(19) United States
(12) Patent Application Publication
(10) Pub. No.: US 2018/0000179 A1
(43) Pub. Date: Jan. 4, 2018

(54) DYNAMIC FACE MASK WITH CONFIGURABLE ELECTRONIC DISPLAY

(71) Applicants: Alan Jeffrey Simon, Kensington, MD (US); Roy Feinson, Washington DC, DC (US)

(72) Inventors: Alan Jeffrey Simon, Kensington, MD (US); Roy Feinson, Washington DC, DC (US)

(21) Appl. No.: 15/199,718

(22) Filed: Jun. 30, 2016

(51) Int. Cl. A41G 7/02; G06F 3/14; G09G 5/00

(52) U.S. Cl. CPC A41G 7/02; G09G 5/005; G06F 3/1446; G09G 2380/02

(57) ABSTRACT

A method and a device are disclosed including a face mask with a display configured to show downloaded images. The mask may include a display controller to convert a format of an image to a mask-format to allow display on the irregular shaped and possibly segmented display areas of the mask, and also perform other image processing and display functions such as pixel mapping and separate image coordination. The display controller may break up a single image into multiple sub-images to display on multiple display areas on the mask. One or more cameras may be deployed on the mask to acquire images, such as a facial image of someone else and display it on the mask, in effect, acting like an electronic mirror. The images displayed on the mask may be downloaded and controlled from an app on a mobile device such as a smartphone.

### TECHNICAL FIELD

This application relates generally to face masks. More specifically, this application relates to a face mask with electronic configurable display that can change images and patterns displayed on the mask.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1;

FIG. 3 shows an example dynamic electronic face mask with configurable display sections usable with the computing device of FIG. 2;

FIG. 4 shows an example logical pixel mapping dynamic electronic face mask of FIG. 3 with several display sections and configurable pixel addressing;

FIG. 5 shows an example pixel grid with address lines for individual pixel addressing;

FIG. 6 shows an example set of irregular shaped pixel sets logically organized as grids for addressing, but physically having irregular shapes;

FIG. 7 shows an example dynamic electronic mask having an embedded display controller;

FIG. 8 shows an example dynamic electronic mask having and Input/Output (I/O) processor in communication with a display controller separate from the mask;

FIG. 9 shows an example dynamic electronic mask in communication with a mobile computing device via a receiver;

FIG. 10 shows an example dynamic electronic mask coupled with a separate display control unit;

FIG. 11 shows an example dynamic electronic mask with cameras; and

FIG. 12 shows the example dynamic electronic mask with cameras displaying an image of a face scanned with the cameras.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references an electronic face mask, the disclosures may be applicable to other articles of clothing, such as a shirt, a jacket, shoes, handbags, and the like.

Briefly described, a system and a method are disclosed including a face mask having an electronic display surface configured to display static or video images downloaded to a display memory. In various embodiments, the mask may include a display controller as an integrated or a separate module used to convert a format of an image to allow display on the irregular shaped and possibly segmented display areas of the mask, and also perform other image processing and display functions such as pixel mapping and separate image coordination. In some embodiments, the display controller may break up a single image into multiple sub-images, each displayed on a corresponding sub-display, or display independent images simultaneously on multiple display areas on the mask. In some embodiments, one or more cameras may be deployed on the surface of the mask to acquire images, such as a facial image of someone else and display it on the mask, in effect, acting like an electronic mirror in some respects. In some embodiments, the images displayed on the mask may be downloaded and controlled from an app on a mobile device such as a smartphone.

With the ubiquity of electronic devices, the Internet, and relatively inexpensive memory and computing resources, many applications have become commercially viable. Examples, include realistic video games played in real-time, virtual reality headsets, many types of mobile computing devices such as smartphones, tablets, and watches, and the like. Accordingly, entertainment and novelty items, as well as other graphic applications are in high demand and proliferating.

### Illustrative Operating Environment

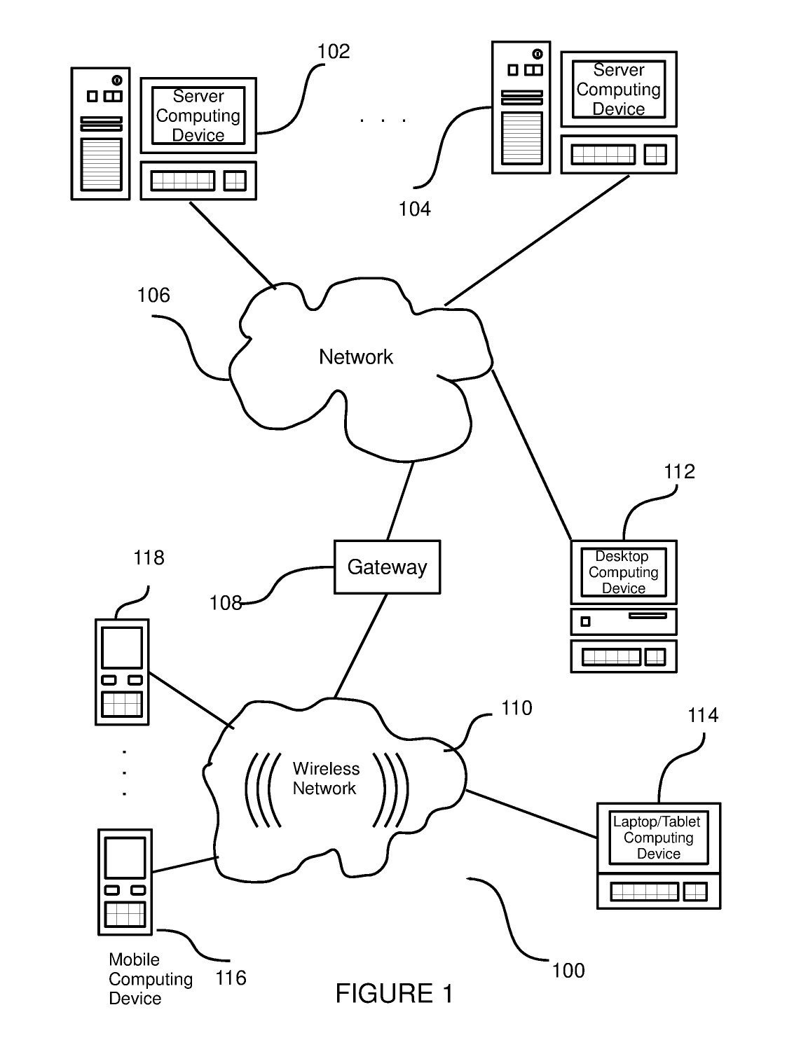

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

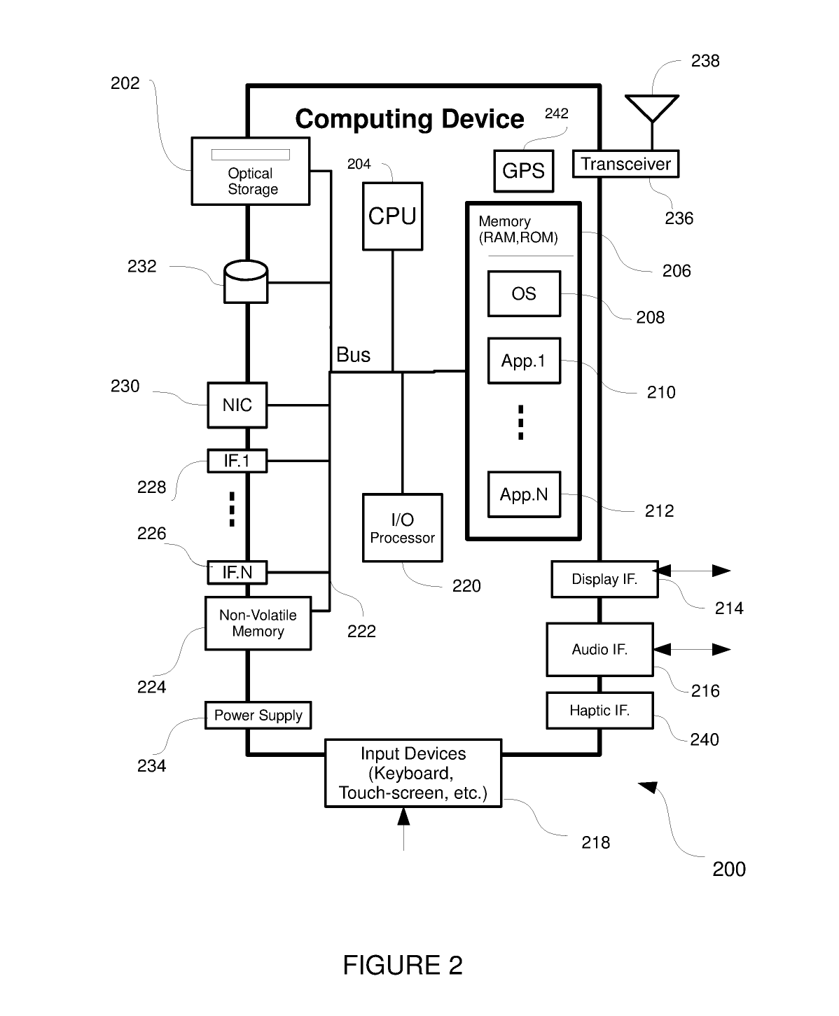

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, or the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 112-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, Bluetooth Low Energy (LE), High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

In various embodiments, the arrangement of system 100 includes components that may be used in and constitute various networked architectures. Such architectures may include peer-to-peer, client-server, two-tier, three-tier, or other multi-tier (n-tier) architectures, MVC (Model-View-Controller), and MVP (Model-View-Presenter) architectures among others. Each of these are briefly described below.

Peer to peer architecture entails use of protocols, such as P2PP (Peer To Peer Protocol), for collaborative, often symmetrical, and independent communication and data transfer between peer client computers without the use of a central server or related protocols.

Client-server architectures includes one or more servers and a number of clients which connect and communicate with the servers via certain predetermined protocols. For example, a client computer connecting to a web server via a browser and related protocols, such as HTTP, may be an example of a client-server architecture. The client-server architecture may also be viewed as a 2-tier architecture.

Two-tier, three-tier, and generally, n-tier architectures are those which separate and isolate distinct functions from each other by the use of well-defined hardware and/or software boundaries. An example of the two-tier architecture is the client-server architecture as already mentioned. In a 2-tier architecture, the presentation layer (or tier), which provides user interface, is separated from the data layer (or tier), which provides data contents. Business logic, which processes the data may be distributed between the two tiers.

A three-tier architecture, goes one step farther than the 2-tier architecture, in that it also provides a logic tier between the presentation tier and data tier to handle application data processing and logic. Business applications often fall in and are implemented in this layer.

MVC (Model-View-Controller) is a conceptually many-to-many architecture where the model, the view, and the controller entities may communicate directly with each other. This is in contrast with the 3-tier architecture in which only adjacent layers may communicate directly.

MVP (Model-View-Presenter) is a modification of the MVC model, in which the presenter entity is analogous to the middle layer of the 3-tier architecture and includes the applications and logic.

Communication links within LANs typically include twisted wire pair or coaxial cable, while communication links between networks may utilize analog telephone lines, full or fractional dedicated digital lines including T1,T2,T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

### Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs and/or software modules/components 210-212. Such software modules and components may be stand-alone application software or be components, such as DLL (Dynamic Link Library) of a bigger application software. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client-side and/or mobile communication operating system such as Windows Mobile™, Android®, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like.

Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC (Media Access Control) address.

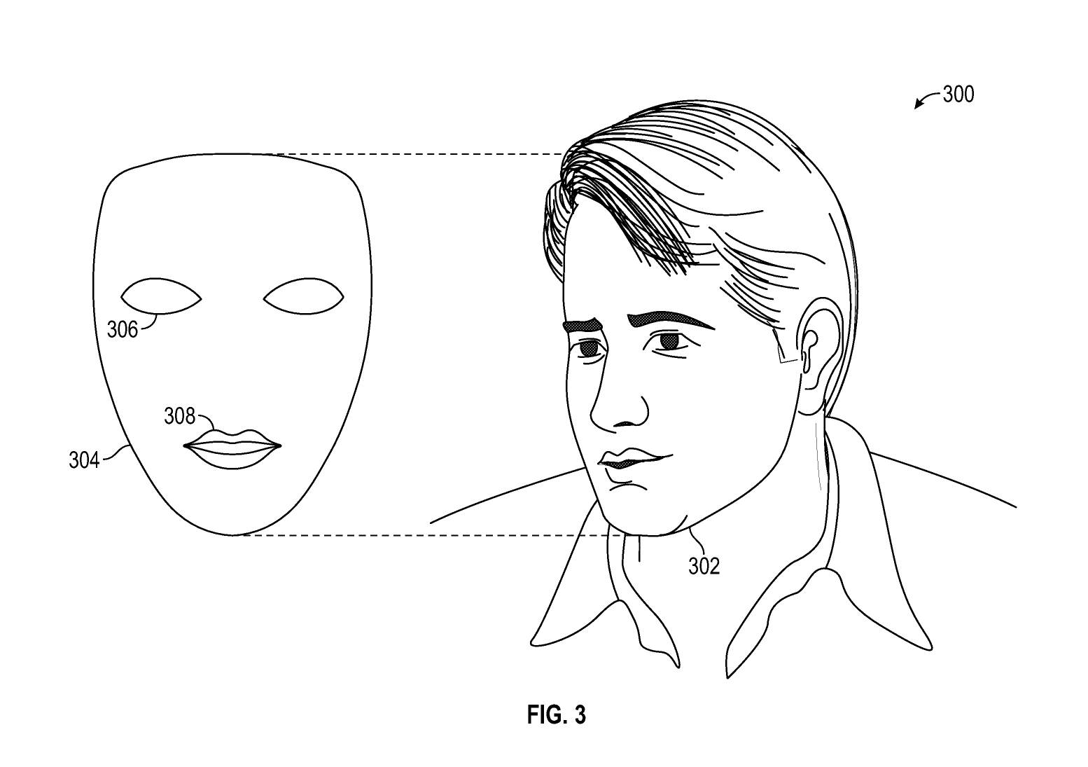

FIG. 3 shows an example dynamic electronic face mask with configurable display sections usable with the computing device of FIG. 2. In various embodiments, an entertainment system may include a Dynamic Electronic Mask (DEM) 304 having cut-out slots for eyes 306 and mouth 308 to fit a face of a person 302.

In various embodiments, the DEM may include one or more flexible display areas that substantially conform to a shape of a human face and can dynamically display changing static images or videos, in contrast to common masks that have a fixed image or color printed on the surface, such as an image of an animated character or a famous historical figure like a former president or a celebrity. In some embodiments, an integrated on-mask or separate off-mask display controller that can display and change various images and videos. The display controller may obtain the images from various sources including mobile devices, directly from the Internet or other computer network, from local or remote storage, or from integrated cameras on the mask.

In various embodiments, the mask includes a contoured body that substantially similar to curves on a human face, and further includes a flexible display material made based on various technologies and manufactured to follow the contours of the mask and have the shape of facial curves such as cheeks, forehead, and chin. Other circuit elements controlling the display, such as controller circuits and memory, may also be made from flexible circuits that may be manufactured to fit facial curves. Such flexible displays and circuits may hold their shapes under normal conditions, such as basic handling and component weights, but may also be bendable and flexible and continue to function normally under moderate manual force without being damaged.

Some of the flexible display technologies include Organic Thin Film Transistors (OTFT), flexible Organic Light Emitting Diode (OLED), Active Matrix OLED (AMOLED), electronic paper (e-paper) manufactured using Self-Aligned Imprint Lithography (SAIL) process, and the like. Those skilled in the art will appreciate that present or future flexible display technology may be employed without departing from the spirit of the present disclosures.

In various embodiments, the dynamic mask may be held in position on a user's face via various techniques such as using a rubber band or string around the head, temples like those on reading glasses, nose clip, mild adhesive applied to skin, vacuum-based techniques like small suction cups or thin-film adhesion, and the like. Those skilled in the art will appreciate that any technique or method suitable for holding a face mask in place may be utilized without departing from the spirit of the present disclosures.

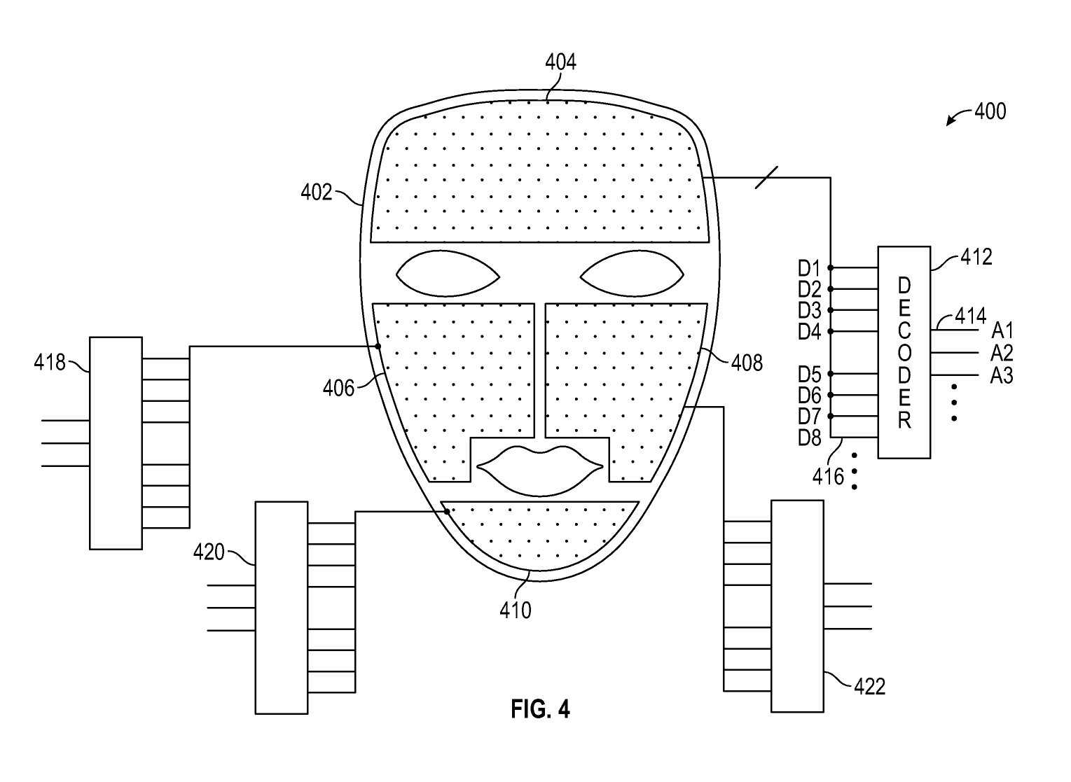

FIG. 4 shows an example logical pixel mapping dynamic electronic face mask of FIG. 3 with several display sections and configurable pixel addressing. In various embodiments, dynamic mask 400 includes a mask body 402, display segments 404, 406, 408, and 410, each display segment including many display elements or pixels (shown as dots) that are individually addressable. Coupled with the display segments are pixel addressing circuits 412 for display segment 404, having input address lines 414 (e.g., A1-A3) and decoded output address lines 416 (e.g., D1-D8). Each segment display may have its own corresponding addressing circuits 418, 420, and 422.

In various embodiments, display segments 404-410 are flexible display segments, which are also separate physically. In other embodiments, the display segments may be physically a single piece or connected while being electrically separate and controlled independently of each other. Pixel addressing may be accomplished using decoders that take a number of input address lines and decode the input combination into one of many output signals. Decoders are well-known in the art. Any other techniques known in the art for memory addressing may also be utilized. In some embodiments, the pixels are arranged in a logical grid, not necessarily a physical square or rectangular grid, in which each pixel is at the intersection of a row and a column signal. When the corresponding row and column signals are activated, the pixel at the intersection also becomes active or turned ON, thus displaying one pixel in a larger image.

In some embodiments, the pixel addressing apparatus may include a number of other components in addition or in place of decoders, such as buffers, shift registers, other memory, display processor, and the like. This apparatus may include a combination of hardware and software or firmware. In some embodiments, each display is supplied with image data from a corresponding memory segment. When a memory segment is loaded with image data, the image data may be transferred to the display via pixel address and data lines for display. Address lines, control lines, and data lines are generally known in the art as buses that connect different components in a computing system, as described with respect to FIG. 2. In some embodiments, the display segments may be dynamically configured to be mapped to different address lines and corresponding display memories to show different images accordingly. For example, if the image of a red flower and a blue flower were being displayed on the left and right sides of the mask, respectively, re-configuring the display segments may cause the red flower to be displayed on the right side and the blue flower on the left side by reprogramming the pixel address lines and swapping the corresponding display memories.

In various embodiments, the display segments 404-410 may have irregular shapes to cover or fit various parts of human face such as cheeks, forehead, and chin. Alternatively, the display segments may include a number of smaller regular shaped segments, such as small squares that cover the face like tiles. The display segments may include two or more segments that cover the wearer's face in various configurations.

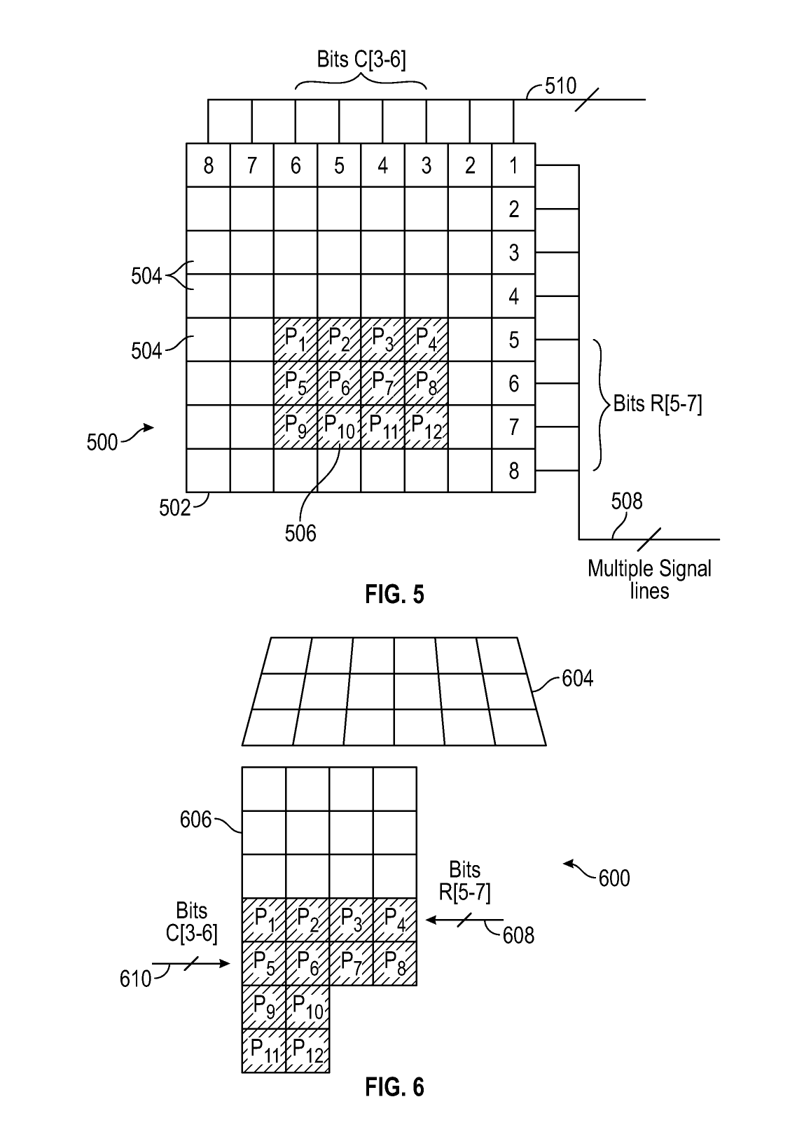

In some embodiments, images, formats, and masks may be traded between third parties without involvement of the mask manufacturer or seller. For example, an exchange market may be created by mask users, in collaboration with or independent of the mask manufacturer, to buy, sell, or exchanges popular images, such as celebrity faces formatted for display on the mask, formatting code to format standard images to fit the mask, as further discussed below with respect to FIGS. 5 and 6, and to buy/sell/exchange complete masks. In some embodiments, a website may be provided from which users may select images for display on their masks.

FIG. 5 shows an example pixel grid with address lines for individual pixel addressing. In various embodiments, display 500 includes a grid 502 having various pixels 504, row buses 508 and column buses 510, each bus including address, control, and data lines. An example area of pixels 506 corresponds to row bits 5-7 and column bits 3-6.

In various embodiments, to display an image, data from display memory is transferred to pixels selected by row and column bits, such as pixels in area 506. Those skilled in the art appreciate that the various bits in address, control, and data buses (collectively called signals, lines, or bits) are enabled under program or circuit control to cause orderly transfer of data from memory to display. The logical and physical arrangement of pixels P1-P12 shown in area 506 are the same. That is, the signal lines or bits of the rows and columns are arranged to correspond to the rows and columns of the pixels, as shown. So, for example, bit 6 of the rows (or row #6) and bit 4 of the columns (or column #4) correspond with row 6 and column 4 of the pixels, respectively. However, the logical and physical arrangements may be different as described with respect to FIG. 6 below.

FIG. 6 shows an example set of irregular shaped pixel sets logically organized as grids for addressing, but physically having irregular shapes. In various embodiments, display segments arrangement 600 include display segments 604 and 606, and the signal bits 608 and 610 used to address and/or access pixels in display segment 606. Signal lines for segment 604 are not shown.

In various embodiments, pixels P1-P12 may not be distributed on a rectangular grid, as shown in FIG. 5. Instead, they may be arranged in a different and irregular configuration. Nevertheless, these pixels are coupled to and controlled by the same bits as a rectangular grid. That is, the topology of the pixels and signals is the same as a grid even though the physical arrangement may not be.

In various embodiments, the bits may be remapped and coupled to different pixels so that enabling the same bits cause a different pixel being activated to display an image. The remapped pixels may be within the same display segment or different segments. In some embodiments, individual pixels or entire segments may be remapped to different bits. For example, buses 608 and 610 may be remapped to activate pixels within display segment 604 instead of 606.

In various embodiments, reprogrammable or remappable bits allow various image manipulations to be displayed on the mask. The memory contents corresponding with different display segments may also be swapped to achieve similar effects. In some embodiments, image format may not allow easy change or swap of memory contents without further processing, while swapping bits in real time may be faster, easier, and less computing intensive to achieve the same effect.

In various embodiments, the image to be displayed on a display segment may need to be formatted specially based on segment shape to display properly on the irregular shaped segment. In some embodiments, the shape of the segment may be preprogrammed in hardware, software, firmware, or loadable file for use by the display controller or display driver. For example, if a display segment has an irregular shape, such as segment 406 shown in FIG. 4, the upper portion of the display may be broader while the lower part is narrower and/or has a stepped portion abruptly becoming narrower. For such a display shape, the image to be displayed may have to be scaled, truncated, fit to frame, be assigned lower resolution (for example, by eliminating every other pixel to narrow it down), and the like to be displayable on the narrow portions. Conversely, for broader portions of the display segment, the image may have to be stretched, be padded (by copying adjacent pixels to increase size), or otherwise appropriately adjusted to fit the wider display width on the same display segment.

In various embodiments, a mask-format is an arrangement of image pixels specifically for display on a segment of the mask with particular and often irregular geometric shape. Such mask formats are generally done by the display controller described herein using software and/or firmware having programmed in or having access to the information of the display segment configuration, including shape, dimensions, number of pixels, pixel addressing information and any other information necessary to format a raw image (or standard format image) to the mask-format. Such formatting information may be encoded in the software/firmware itself or encoded in a data file readable and usable by the formatter software. In various embodiments the mask image formatter software is one or more modules designed for manipulating and changing pixels in an image to fit the display segment on the mask.

In operation, an image may be downloaded for display on an irregular shaped display segment into the display memory. The display controller may then use the predetermined format provided for the particular segment to convert the image from a standard format, such as a JPEG format designed for a rectangular screen, to a custom mask format suitable for the particular mask or segment.

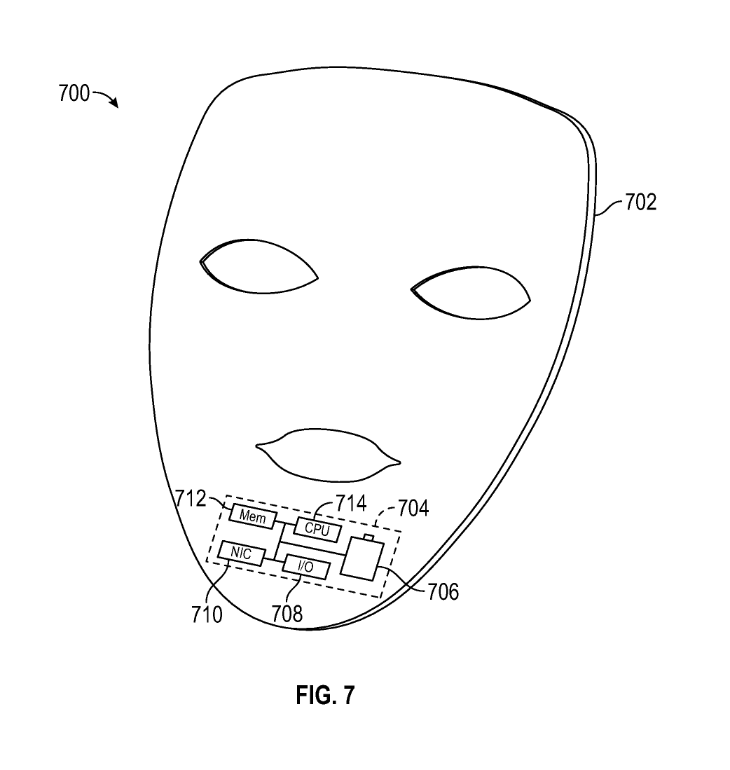

FIG. 7 shows an example dynamic electronic mask having an embedded display controller. In various embodiments, the integrated dynamic mask 700 may include a mask body 702, having an embedded controller board 704 including a power source 706, an Input/Output (I/O) module 708, a Network Interface Card (NIC) 710, memory 712, and a Central Processing Unit (CPU) 714 all connected via electronic signal busses for data transfer and control.

In various embodiments, the controller board 704 may be a thin flexible circuit with minimal power requirements to download image data from an external source via NIC 710, store in memory 712, convert to mask format for the mask display, transfer formatted image on the mask via I/O 708 and drive the display on the mask for actual display.

In various embodiments, the power source may be a small flat battery, a rechargeable battery or capacitor, or other compact suitable power source.

In various embodiments, the NIC may be in contact with an external source, such as a mobile computing device like a cellphone or tablet, or a larger computer, the internet, and the like, to download new images. In some embodiments, the NIC may be used during an initialization period to preload any images to display and then stop data acquisition until a next session as determined and controlled by a user (for example, by pressing a button to activate new data acquisition), or by the mask being turned OFF and ON again. In other embodiments, the NIC may continuously be connected to a data source download new data while the mask is in use, so it can update displayed images in real time. In some embodiments, the NIC may be part of an IOT (Internet Of Things) system with its own IP address directly connected to the Internet to download images from a predetermined website or multiple websites the addresses (URL) of which may be embedded in the display controller. In some embodiments, the NIC may be connected by wireless, such as WiFi, or wired, such as USB, links to a device, such as a smartphone.

In various embodiments, the controller board 704 may perform all or some of the formatting of the image to be displayed on the mask. It may further include software and/or firmware that performs other signal and image processing, such as filtering, color change, image animation, swapping of display segments, scaling and/or truncating images, stretching, and the like. In some embodiments, the embedded software may change color themes such as background and foreground colors. The animation performed may be image translation (a virtual perceived motion across screen by successively moving pixels in a consistent direction on the screen to create illusion of motion), fading in and out, and other visual effects such as image spinning, bouncing, flipping, and the like, all by virtual motion of image pixels.

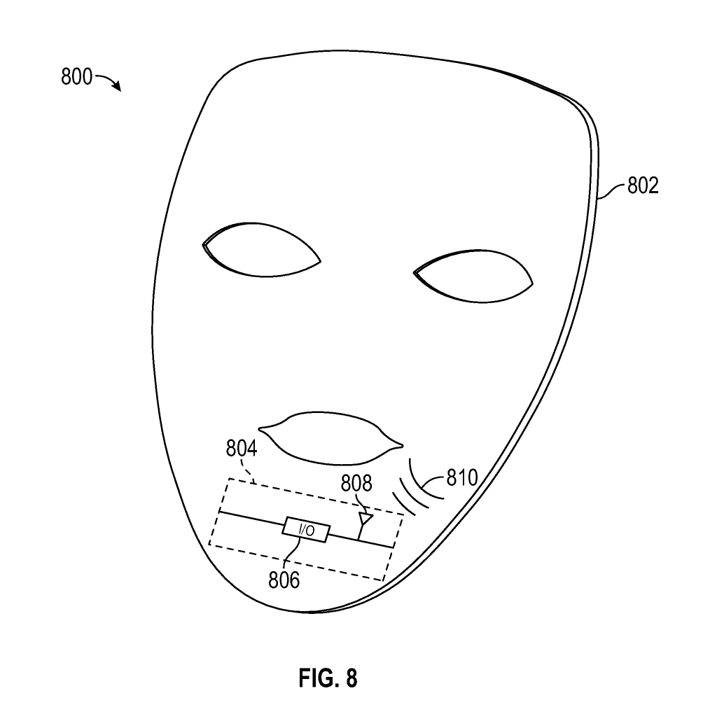

FIG. 8 shows an example dynamic electronic mask having and Input/Output (I/O) processor in communication with a display controller separate from the mask. In various embodiments, dynamic mask 802 includes a limited control circuit 804 with an I/O module 806 to transfer display data, and an antenna 808 for receipt and/or transmission of radio waves 810.

In various embodiments, a power source, such as a small flat battery or a rechargeable battery or capacitor (not shown) or other compact suitable power source may be used to power the circuit.

In various embodiments, the rest of the circuit needed to control the mask display may be located off the mask and in another location, such as a belt unit carried by the user. Such belt unit may include a NIC that may be in contact with an external source, such as a mobile computing device like a cellphone or tablet, or a larger computer, the internet, and the like, to download new images. The NIC may also be in contact with the antenna 808 to transmit and/or receive data from to/from the limited control circuit 804 via wireless communications or a hardwired interface, such as a mini USB. In some embodiments, the belt unit includes the components needed to download and format images from external sources, similar to the components shown in FIG. 7. In various embodiments, the NIC may be used during an initialization period to preload any images to display and then stop data acquisition until a next session as determined and controlled by a user (for example, by pressing a button to activate new data acquisition), or by the mask being turned OFF and ON again. In other embodiments, the NIC may continuously be connected to a datasource download new data while the mask is in use, so it can update displayed images in real time. In some embodiments, the NIC may be part of an IOT (Internet Of Things) system with its own IP address directly connected to the Internet to download images from a predetermined website or multiple websites the addresses (URL) of which may be embedded in the display controller. In some embodiments, the NIC may be connected by wireless, such as WiFi, or wired, such as USB, links to a device, such as a smartphone.

In various embodiments, the formatting of the image takes place on the belt

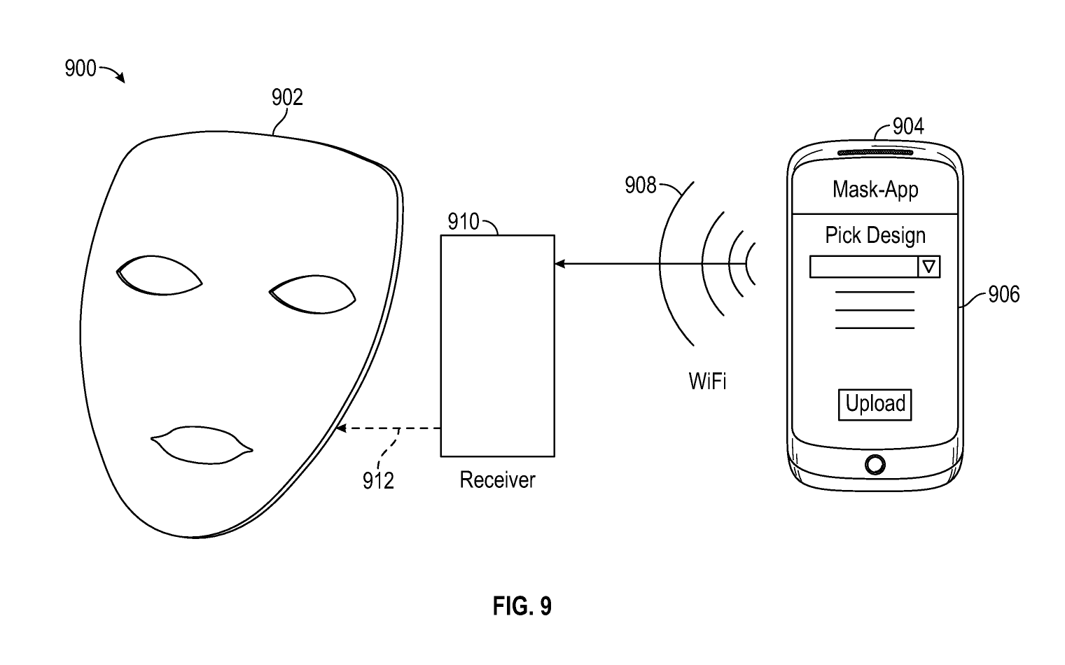

FIG. 9 shows an example dynamic electronic mask in communication with a mobile computing device via a receiver. In various embodiments, smartphone arrangement 900 may include a dynamic mask 902 in contact with a transmitter/receiver 910 via an interface 912 to receive wireless signals 908 from a smartphone 904 running an app (small mobile software application) usable to download images to the mask.

In various embodiments, the mask 902 may be similar to the mask of FIG. 8, in which a small local circuit is deployed within the mask to receive and display the data after formatting. In an illustrative operation, the app 906 running on smartphone 904 may transmit image data via wireless signals to the receiver 910. The receiver 910 may include other processing components, such as CPU and memory to format the transmitted image for display on the mask via mask interface 912. The interface may be wired, such as USB or wireless signals such as WiFi, NFC (Near Field Communication), Bluetooth, or other similar wireless protocols. In these embodiments, the receiver/computing unit 910 may receive standard images from the smartphone and then format it for display on the mask. In other embodiments, the mask may include display segments without any processing components. In such embodiments, the formatted image is directly displayed via data and control busses contained within the device 910.

In some embodiments, the mask app 906 may download a standard format image, such as JPEG, bitmap, and the like, from the Internet and then format it for display on the mask before transmitting it to the receiver for display on the mask. The app may include additional interfaces for defining the configuration of mask segments for formatting. It may also include options for the user to select various animation modes or other image manipulation to be displayed on the mask. Such selections may be performed during a setup session before activating or using the mask.

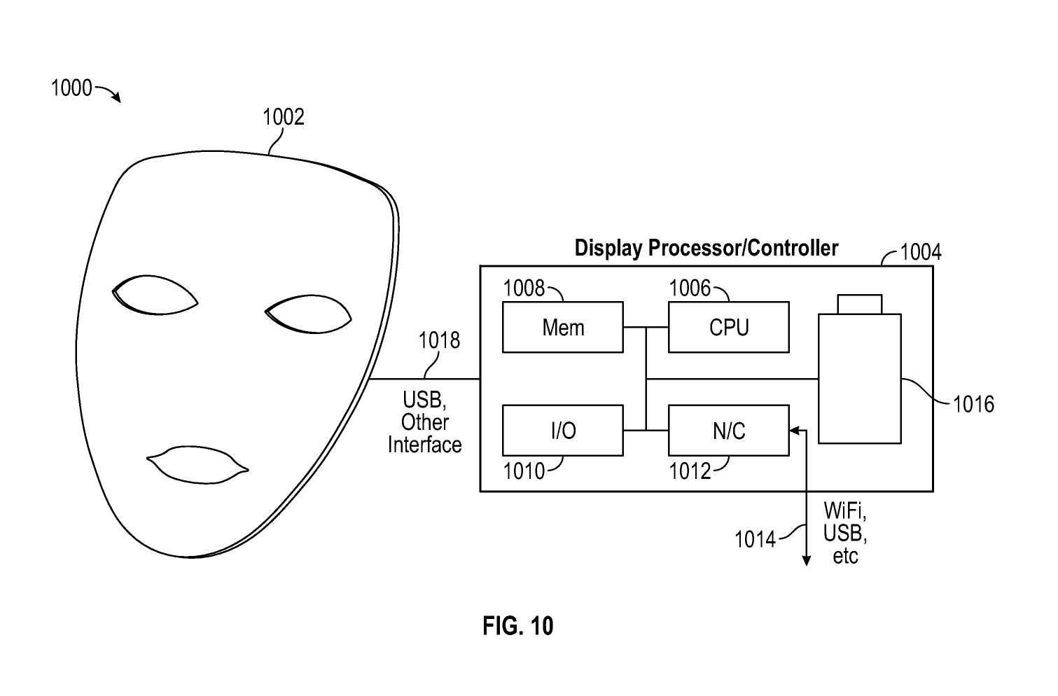

FIG. 10 shows an example dynamic electronic mask coupled with a separate display control unit. In various embodiments, external controller arrangement 1000 may include a dynamic mask 1002 in contact with an external display controller board/unit 1004, via an interface 1018 to receive image data for display. The controller board may include various computing components such as memory CPU 1006, memory 1008, I/O module 1010, NIC module 1012, and power pack 1016.

In various embodiments, the mask receives the formatted image data via interface 1018 and does not perform any processing locally and does not need a local power supply.

In some embodiments, the display processor/controller 1004 may be preprogrammed to format a standard image for the particular mask it is coupled to. It may include firmware or downloadable programs to perform all the image manipulation necessary to display the final form of the image and its effects (such as image animation, color theme, etc., discussed herein). The controller may further include a NIC interface for connecting to data sources such as computers, tablets, smartphones or directly to the internet to download image data. The NIC module as well as mask interface 1018 may be wired, such as USB, or wireless such as WiFi, NFC (Near Field Communication), Bluetooth, or other similar wireless protocols. In these embodiments, the display controller 1004 may receive standard images from various sources and then format them to generate mask-format images for display on the mask.

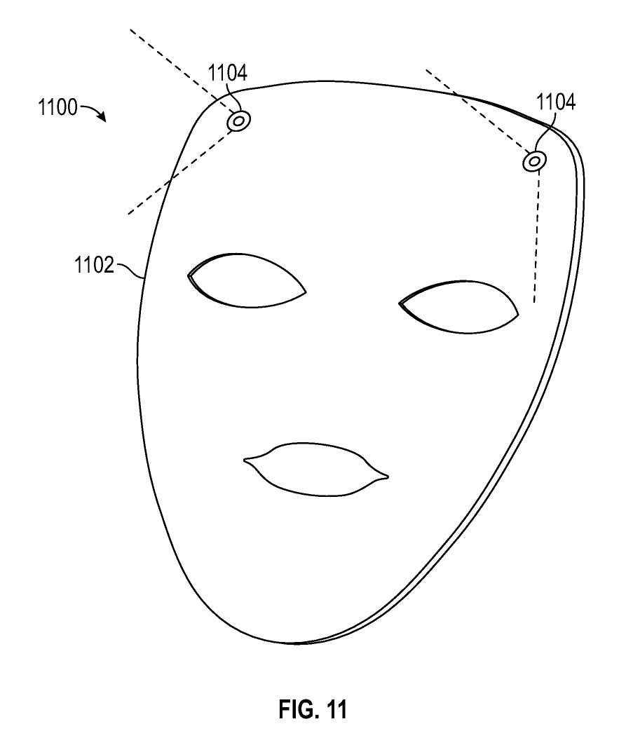

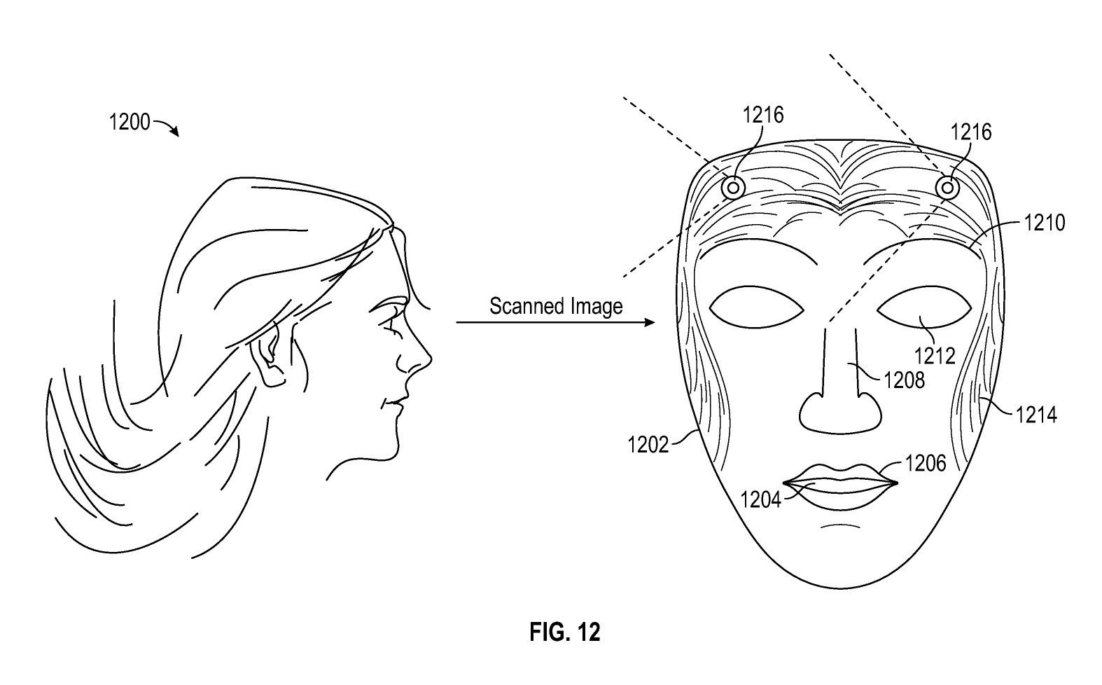

FIG. 11 shows an example dynamic electronic mask with cameras. In various embodiments, dynamic mask 1100 includes a mask body 1102 and one or more scanning cameras to obtain images visible to the mask.

In various embodiments, the scanning cameras may be activated, for example, by pressing a button or sending a wireless signal using a remote control device, by the mask wearer/user to scan an image of a scene, a face, an object, and the like for formatting and display on the mask.

In some embodiments, the raw image obtained by the cameras is processed and formatted on the mask in embodiments in which the display controller is integrated with the mask. In other embodiments in which the controller is separate, for example, on a smartphone or a belt unit, the raw image may be sent to the off-mask controller for formatting and transmitting back to the mask for display.

For example, the camera may be used to obtain the image of a flower, a lake, a city scape, or other scenery, format for display on the mask and then to display in real time as the mask user looks at various scenery. In effect, the mask may act as an electronic mirror that reflects the scenery the wearer is seeing on the mask and formatted for the particular mask. In some embodiments, the user can freeze the image on the mask at any point he wants by discontinuing camera scanning and leaving the last image obtained on the mask.

FIG. 12 shows the example dynamic electronic mask with cameras displaying an image of a face scanned with the cameras. In various embodiments, a face scan arrangement 1200 includes a mask body 1202, with cameras 1216 to scan a face of another person, and show her features on the mask. Such facial features may include lips 1206 distinct from the mouth slit 1204 built into the mask, nose 1208, eyebrows 1210 displayed above the eye slits 1212 built into the mask, and hair 1214.

In various embodiments, face and/or facial features recognition software deployed/installed within the display controller, whether integrated with the mask or off-mask on a smartphone or belt unit, may be used in addition to the image formatter software used to format standard images into mask-format for display on the mask, to properly display the features in the appropriate positions on the mask, without distortion of the facial features. For example, the facial features recognitions software, in collaboration with the mask display formatter software, will display the eyebrows of the image scanned from a third person's face, above the eye slits 1212 of the mask, even if the initial scan by the cameras is from an angle that would reflect the eyebrow on the cheek segment of the mask, if the mask were to behave like a straight mirror. That is, the facial feature recognition recognizes the eyebrow as eyebrows and place it above the eye slits during mask-formatting in the image to be displayed on the mask. This way, a mask wearer may scan the face of a friend, which is then reflected on the mask and he can greet his friend with the friend's own face, as a gesture of novelty.

It will be understood that each step of the processes described above, and combinations of steps, may be implemented by computer program instructions. These program instructions may be provided to a processor to produce a machine, such that the instructions, which execute on the processor, enable implementing the actions specified. The computer program instructions may be executed by a processor to cause a series of operational steps to be performed by the processor to produce a computer implemented process such that the instructions, which execute on the processor to provide steps for implementing the actions. The computer program instructions may also cause at least some of the operational steps to be performed in parallel. Moreover, some of the steps may also be performed across more than one processor, such as might arise in a multi-processor computer system. In addition, one or more steps or combinations of steps described may also be performed concurrently with other steps or combinations of steps, or even in a different sequence than described without departing from the scope or spirit of the disclosure.

Accordingly, steps of processes or methods described support combinations of techniques for performing the specified actions, combinations of steps for performing the specified actions and program instruction for performing the specified actions. It will also be understood that each step, and combinations of steps described, can be implemented by special purpose hardware based systems which perform the specified actions or steps, or combinations of special purpose hardware and computer instructions.

It will be further understood that unless explicitly stated or specified, the steps described in a process are not ordered and may not necessarily be performed or occur in the order described or depicted. For example, a step A in a process described prior to a step B in the same process, may actually be performed after step B. In other words, a collection of steps in a process for achieving an end-result may occur in any order unless otherwise stated.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. A facial mask, comprising:
a mask body;
a flexible display segment substantially following contours of the mask body and configured to receive and display images obtained externally; and
a controller coupled with the flexible display segment to control the display of images.

2. The facial mask of claim 1, further comprising a network connection to obtain images.

3. The facial mask of claim 1, wherein the controller is configured to convert a format of an obtained image to a mask format for display on the flexible display format.

4. The facial mask of claim 1, wherein the controller comprises a Central Processing Unit (CPU) and a memory module and is in communication with a mobile computing device.

5. The facial mask of claim 1, wherein a plurality of flexible display segments are employed.

6. The facial mask of claim 1, wherein the obtained images comprises a video clip.

7. The facial mask of claim 1, wherein the flexible display segment has an irregular shape with individually addressable pixels.

8. The facial mask of claim 1, wherein the controller is separate from the facial mask.

9. A wearable display system, comprising:
a facial mask body;
a flexible display segment coupled with the facial mask; and
a controller coupled with the flexible display segment to control a display of images obtained externally, wherein the controller is configured to obtain images and videos via a network connection.

10. The wearable display system of claim 9, further comprising a mobile computing device in communication with the controller to supply images for display.

11. The wearable display system of claim 9, further comprising scanning cameras integrated with the facial mask body to obtain images directly.

12. The wearable display system of claim 9, wherein the controller converts a standard format of an obtained image to a mask format displayable on the flexible display segment.

13. The wearable display system of claim 9, wherein a plurality of reconfigurable flexible display segments are coupled with the mask body to display and swap respective display images in real time.

14. The wearable display system of claim 9, wherein the controller includes a Central Processing Unit (CPU), a memory module, a Network Interface Card (NIC), and a power source all integrated with the mask body.

15. A method of changing a facial mask, the method comprising:
obtaining an image from an external source;
formatting the image to be displayable on a flexible display segment coupled with the facial mask; and
displaying the formatted image on the flexible display segment.

16. The method of claim 15, further comprising changing images in real time for display.

17. The method of claim 15, further comprising communicating with a mobile computing device to configure the flexible display segment and obtain images for display.

18. The method of claim 15, further comprising obtaining images directly from scanning cameras integrated with the facial mask.

19. The method of claim 15, wherein obtaining an image comprises obtaining a facial image of another person scanned by cameras integrated with the facial mask and using a facial features recognition software module to display scanned facial features of the other person appropriately on the mask without facial distortion.

20. The method of claim 15, wherein the formatted image is specifically created for an irregular shape of the flexible display segment.

21. The method of claim 15, wherein the formatted image is obtained from a mask image exchange market.
